(19) United States
(12) Patent Application Publication
(10) Pub. No.: US 2001/0016843 A1
(43) Pub. Date: Aug. 23, 2001

(54) METHOD AND APPARATUS FOR ACCESSING DATA

(76) Inventors: TODD OLSON, PITTSBURGH, PA (US); BRIAN MUELLER, PITTSBURGH, PA (US); JEREMIAH LOTT, PITTSBURGH, PA (US); ANIL MENON, SEATTLE, WA (US)

Correspondence Address: ANSEL M SCHWARTZ, ONE STERLING PLAZA, 201 N CRAIG STREET, SUITE 304, PITTSBURGH, PA, 15213

(21) Appl. No.: 09/246,524

(22) Filed: Feb. 8, 1999

(51) Int. Cl. G06F 17/30

(52) U.S. Cl. 707/3; 707/4; 707/10

(57) ABSTRACT

A system for accessing data. The system includes a memory mechanism having the data. The system includes a mechanism for processing a query for the memory mechanism which is icon based. A system for accessing data. The system includes a memory mechanism having N heterogeneous memory sections having the data. The system includes a mechanism for processing queries for at least two of the N memory sections. A system for accessing data. The system includes a mechanism for processing queries along respective query paths for the memory mechanism. The processing mechanism has predefined query paths to process queries. A method for accessing data. A system for accessing data. The system includes a design time processing portion and a run time processing portion. A system for accessing data. The system includes a memory mechanism having N memory sections having the data. The system includes a mechanism for processing a query which simultaneously obtains data from the N memory sections. A system for accessing data. The system includes a physical layer, binder and virtual layer.

### FIELD OF THE INVENTION

The present invention is related to a method and system for accessing data in a memory. More specifically, the present invention is related to a method and system for accessing data with a query that has no knowledge of the format of the data stored in a memory and/or is prepared in a design time processing portion separate from a run time portion which operates on the query and/or which simultaneously obtains data from separate memory location responsive to the query and/or which has a virtual layer in which the query is formed in a virtual layer, operated upon by a binder so data responsive to the query can be obtained from a physical layer.

### BACKGROUND OF THE INVENTION

The present invention pertains to a system, otherwise known as Cerebellum, which is the next-generation enterprise application development product based on total data independence. Cerebellum's graphical interface allows database developers to quickly create applications that manage, extract, and display information from any data source located anywhere. Unlike manually programming and integrating multiple data environments, Cerebellum enables developers to focus on design and architecture, not coding.

Because Cerebellum is not dependent on any particular database type, enterprise application generation is achieved quickly and efficiently by eliminating data access and incompatibility problems. A current issue in mid- to large-sized corporations is the existence of numerous databases running on different platforms, networks, and applications and in different geographical locations. Corporations are significantly challenged to easily access and integrate information, making application development a time- and resource-draining endeavor. A recent study conducted by the Meta Group determined that the typical Global 2000 corporation maintains more than 49 enterprise applications and spends 25-33% of its IT budget on application interoperability solutions. The Gartner Group reports 60-70% of application development costs are spent just on trying to access data.

Because Cerebellum allows managers to use existing database technologies without the need for highly skilled and highly specialized development teams, managers can deploy new enterprise applications in less time and at reduced cost.

### SUMMARY OF THE INVENTION

The present invention pertains to a system for accessing data. The system comprises a memory mechanism having the data. The system comprises a mechanism for processing a query for the memory mechanism which is icon based. The memory mechanism is connected to the processing mechanism.

The present invention pertains to a system for accessing data. The system comprises a memory mechanism having N heterogeneous memory sections having the data, where N is greater than or equal to 2 and is an integer. The system comprises a mechanism for processing queries for at least two of the N memory sections. The memory mechanism is connected to the processing mechanism.

The present invention pertains to a system for accessing data. The system comprising a memory mechanism having the data. The system comprises a mechanism for processing queries along respective query paths for the memory mechanism. The processing mechanism has predefined query paths to process queries. The memory mechanism is connected to the processing mechanism.

The present invention pertains to a method for accessing data. The method comprises the steps of formulating a query for a memory mechanism having the data by selecting an icon on a computer screen to form an icon based query. Then there is the step of processing the icon based query for the memory mechanism.

The present invention pertains to a system for accessing data. The system comprises a design time processing portion which prepares a query for data into a desired query form. The system comprises a run time processing portion which operates on the desired query form solely to obtain data responsive to the desired query form. The run time processing portion is connected to but separate and apart from the desired design time processing portion.

The present invention pertains to a system for accessing data. The system comprises a memory mechanism having N memory sections having the data, where n is greater than or equal to 2 and is and integer. The system comprises a mechanism for processing a query which simultaneously obtains data from the N memory sections.

The present invention pertains to a system for accessing data. The system comprises a physical layer in which data having a format is stored. The system comprises a virtual layer in which a query is formed regarding the data. The query has no knowledge of the format of the data in the physical layer and is independent of the format of the physical layer. The system comprises a binder which operates on the query to obtain data responsive to the query. The binder is connected to the physical layer and the virtual layer.

### BRIEF DESCRIPTION OF THE DRAWINGS

In the accompanying drawings, the preferred embodiment of the invention and preferred methods of practicing the invention are illustrated in which:

FIG. 1 is a schematic representation of a system of the present invention.

FIG. 2 shows elements of the system's graphical query language.

FIG. 3 shows elements of the system's graphical query language arranged in a diagram.

FIG. 4 is a schematic representation of the relationship of agencies to agents. Agents are always associated with agencies; an agent may be owned and managed by more than one agency.

FIG. 5 is a schematic representation of the relationship of agencies to physical machines.

FIG. 6 is a schematic representation of agencies as servers.

FIG. 7 is a schematic representation of the relationship of the agencies to data sources to physical machines.

FIG. 8 is a block diagram regarding statements of the system.

FIG. 9 is a block diagram of statements of the system.

FIG. 10 as a block diagram regarding columns of the system.

FIG. 11 is a schematic representation of an alternative embodiment of a system of the present invention.

### DETAILED DESCRIPTION

Referring now to the drawings wherein like reference numerals refer to similar or identical parts throughout the several views, and more specifically to figure thereof, there is shown a system 10 for accessing data. The system 10 comprises a memory mechanism 12 having the data. The system 10 comprises a mechanism 14 for processing a query for the memory mechanism 12 which is icon based. The memory mechanism 12 is connected to the processing mechanism 14.

The present invention pertains to a system 10 for accessing data. The system 10 comprises a memory mechanism 12 having N heterogeneous memory sections 16 having the data, where N is greater than or equal to 2 and is an integer. The system 10 comprises a mechanism 14 for processing queries for at least two of the N memory sections 16. The memory mechanism 12 is connected to the processing mechanism 14.

The present invention pertains to a system 10 for accessing data. The system 10 comprising a memory mechanism 12 having the data. The system 10 comprises a mechanism 14 for processing queries along respective query paths for the memory mechanism 12. The processing mechanism 14 has predefined query paths to process queries. The memory mechanism 12 is connected to the processing mechanism 14.

The present invention pertains to a method for accessing data. The method comprises the steps of formulating a query for a memory mechanism 12 having the data by selecting an icon on a computer screen to form an icon based query. Then there is the step of processing the icon based query for the memory mechanism 12.

The present invention pertains to a system 10 for accessing data. The system 10 comprises a design time processing portion 18 which prepares a query for data into a desired query form. The system 10 comprises a run time processing portion 20 which operates on the desired query form solely to obtain data responsive to the desired query form. The run time processing portion 20 is connected to but separate and apart from the desired design time processing portion 18.

Preferably, the design time processing portion 18 includes a GUI layer 22 in which a query is specified. The design time processing portion 18 preferably includes a parser 24 layer connected to the GUI layer 22 which converts the query from the GUI layer 22 into a desired form.

Preferably, the run time processing portion 20 has physical memory sections 16, and wherein the design time processing portion 18 includes a binder 28 that takes the query and references physical memory sections 16 to it. The binder 28 is connected to the parser 24 layer. The design time processing portion 18 preferably includes a partitioner 26 layer which separates the query into fragments. The partitioner 26 layer is connected to the binder 28.

Preferably, the design time processing portion 18 includes a generator 30 layer which creates agents 38 responsible for executing the fragments. The generator 30 layer is connected to the partitioner 26 layer. The run time processing portion 20 preferably processes the agents 38.

The present invention pertains to a system 10 for accessing data. The system 10 comprises a memory mechanism 12 having N memory sections 16 having the data, where n is greater than or equal to 2 and is and integer. The system 10 comprises a mechanism 14 for processing a query which simultaneously obtains data from the N memory sections 16.

Preferably, the processing mechanism 14 includes a partitioner 26 which creates a plan for simultaneously obtaining data from the N memory sections 16 in response to the query.

The present invention pertains to a system 10 for accessing data. The system 10 comprises a physical layer 32 in which data having a format is stored. The system 10 comprises a virtual layer 34 in which a query is formed regarding the data. The query has no knowledge of the format of the data in the physical layer 32 and is independent of the format of the physical layer 32. The system 10 comprises a binder 28 which operates on the query to obtain data responsive to the query. The binder 28 is connected to the physical layer 32 and the virtual layer 34.

Preferably, the physical layer 32 includes a plurality of memory sections 16, each memory location having a minimum number of properties. The blinding layer preferably maps a query to data in the memory sections 16. Preferably, the binder 28 filters which data from the memory sections 16 can be provided in response to the query.

Data is a scarce and expensive resource. Data must be protected from unintended damage, loss, or inadvertent disclosure. Therefore, a distributed database management system 10 must be able to protect data on the micro level, such as inserts into tables, selects from data sources, and updates to data. And the system 10 must be able to protect data on the macro level, such as support for user accounts, controlled use of Cerebellum resources, and validated access to existing data sources.

The architecture must guarantee the security of the data.

A distributed database management system 10 should separate information gathering issues from the manipulating and processing of information. In other words, the graphic user interface should be a modular entity, independent of the application's internal logic, available to be customized. For example, either of the Presentation-Abstraction-Control or Model-View-Controller design patterns would satisfy this criterion.

A distributed database management system 10 must deal not only with a distributed world, but with a heterogeneous world, a world in which data exists in a great variety of formats, hardware platforms, access protocols, and object models.

The architecture should not lock the client into a given format, but should instead provide the client the flexibility to integrate existing, disparate data sources.

Computing environments change: networks, operating systems, and application packages are constantly added or subtracted from existing frameworks. The architecture should be able to absorb these changes in as painless manner as possible.

Typically, processing a query against a datasource consists of the following phases:

1. Query specification

The user constructs the query using a suitable GUI interface.

2. Query resolution

The query processing system figures out what the user wants to know.

3. Query Optimization

Query fragmentation

The original query may span several distributed datasources, and it may be broken into a series of query fragments or partitions. The fragments are created on the basis of a variety of considerations such as data source locations and required fields.

Query Rewriting Often the query can be recast into a form that is more optimal from the datasource's point of view. The query is rewritten using a series of transformations into a form optimized for execution.

4. Query Execution

The optimized, fragmented queries are executed and the results displayed to the user.

Architectural decisions that involve the first three phases, query specification, resolution, and optimization are really design time decisions. The final phase involves run time issues. Though these operations may appear uniform to the user, from the system's point of view the creation and the execution of queries are two very different processes.

Instead, the Cerebellum architecture is a bipartite one, consisting of a design-time subsystem and a run-time subsystem. This allows Cerebellum to exploit the best features of both the layered architectural pattern and pipe-and-filter design pattern. The CORBA infrastructure constitutes the “pipes”, and the agents 38, the “filters”.

Within Cerebellum, a set of well defined layers addresses the design-time issues that arise in processing a query, issues such as the specification, translation, optimization, and implementation of queries. An interacting set of CORBA/Java agents 38 addresses the run-time issues, issues involving the execution of queries. See FIG. 1, the concept frame illustrates the layers, their relations, and the issues each addresses.

The layered architecture has long been thought of as a logical and structural dual to the pipe-and-filter architecture; the strengths of the one are usually the weaknesses of the other, and conversely. For example, layered systems enable excellent error control, allow dependencies to be localized to the layer level, and can be made to support several implementations of a given layer. On the other hand, such systems are usually monolithic, and often prove to be slower than their pipe-and-filter counterparts. Pipe and filter systems are independent as well, but at a much finer grain, as in the level of the filters. These systems are rarely monlithic. If anything, they tend to err in the opposite direction.

In the Cerebellum architecture, the goal was to play on the advantages of each while addressing their well known weaknesses. The mapping of the design time architecture to a layered model, and the run time architecture to the pipe-and-filter model was one important step in achieving this goal.

However, the integration of these two subsystems is a non-trivial task (described in greater detail below). Cerebellum achieved this by having the layered design-time architectures produce the basic ingredient required to make the pipe-and-filter architecture work, namely, the agents 38 (filters) themselves. The agents 38 are monitored and run under the supervision of agencies 36, who also provide a variety of other useful services such as persistence, and security.

To a user, Cerebellum appears as a single transparent mechanism to retrieve and manipulate data in disparate, distributed sources.

The design-time subsystem provides the means to specify queries across multiple, heterogeneous, distributed sources of information. To accomplish this, the architecture of the design-time subsystem is layered. At each layer, the security of resources is validated. The actions on the data are controlled based on the user's credentials. Developers can interact with Cerebellum at any level; the simplest approach is to specify a query using the provided GUI.

The design-time subsystem consists of the following layers:

The GUI layer 22: Allows users to specify a query.

The Parser 24 layer: Converts the information collected by the GUI layer 22 into a form Cerebellum can use.

The Partitioner 26 layer: Passes the translated query to the partitioner 26 layer for optimization. This fragments the query into pieces, and rewrites each piece for optimal execution.

Generator 30 layer: Creates the agents 38 responsible for executing the query fragments the partitioner 26 produces.

Cerebellum provides a standard GUI that allows users to specify queries by means of an innovative visual query language. Developers, however, are free to provide their own GUI to interact with Cerebellum. For example, a query could be specified via an HTML form, or passed as a parameter via a library call to Cerebellum. Less sophisticated users may specify a query via the standard GUI. The standard GUI is built around a Graphic Query Language (GQL).

A number of languages have been devised to specify queries. The most common language used to query relational databases is Structured Query Language (SQL) and its derivatives. Other languages like COBOL and OQL support non-relational legacy systems, systems such as VSAM, and object oriented databases.

In addition, academic researchers have tried to develop visual query languages; most of these have been experimental products not designed with commercial needs in mind. A fundamental problem with the design of query languages is the attempt to define their semantics independently of the semantics of the underlying datasources. For example, several commercial database products claim to have visual query interfaces. However, these are merely thinly disguised syntactic sugar wrappings to mask the complexity of SQL.

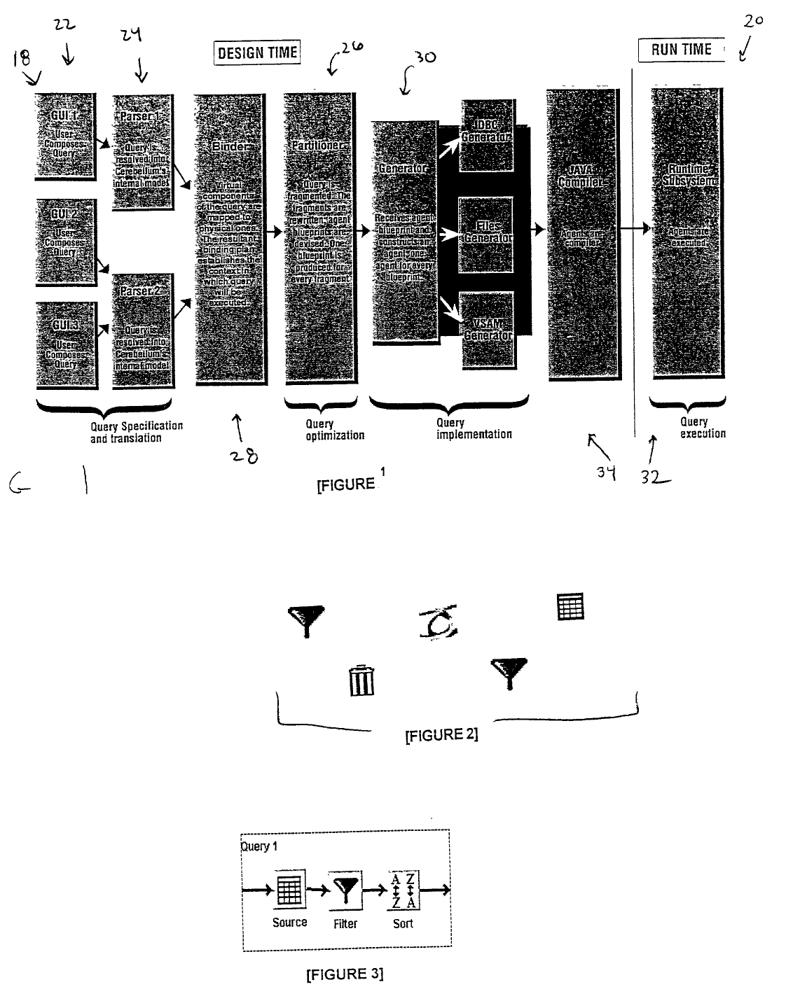

Cerebellum's Graphical Query Language (GQL) is a rational, intuitive, visual query language based on a graph-diagram look-and-feel. The GQL language decomposes queries into elements, where each element is represented graphically. See FIG. 2. The language represents queries as a flow of data through a diagram. Each graphical element represents an action performed on data as it passes through the diagram. See FIG. 3.

Most importantly, the GQL's semantics are independent of the data access and manipulation semantics of particular datasources. It achieves this by:

1. Defining the notion of an abstract query language. For example, there are notions of “abstract inserts” or “abstract selects” and so on. In fact, this language is used as the basis for the internal query model of Cerebellum. The Cerebellum query model constitutes a complete object hierarchy for specifying a query, an object hierarchy independent of any database language or datasource.

2. Associating every datasource with pre-defined metadata objects. These objects can then used for two purposes:

The GUI can access the datasource metadata to determine whether a particular action is meaningful or not. For example, the “join” of two flat files may or may not be permitted depending on the set up of their metadata objects.

The generating layer also uses the metadata to generate datasource specific access and manipulation code.

The GQL begins with graphical elements which represent sources of information. These sources could represent relational database tables, files, or mainframe databases. GQL provides a number of other elements that can operate on the data sources.

| GQL Operators | |
|---|---|
| Join | Merges two streams of information together |
| Select | Limits columns of information to be |
| | contained within the stream of information |
| Insert | Inserts data into a datasource |
| Update | Updates data within a datasource |
| Delete | Deletes rows within a datasource |
| Filter | Limits the rows upon which the action takes |
| | place |
| Aggregate | Aggregates rows of information together |
| | (sum, min, max, avg, count) |
| Sort | Sorts the rows of a query |
| Set Operation | Takes data from two sources and produce |
| | one result |
| Stored Procedure | Includes the work of server-side agents |
| Expression | Performs string, numeric, date functions, or |
| | combinations of functions on data |

GQL supports all major relational database features.

GQL also supports reuse. Users can easily save and reuse queries. These saved queries can be used as sources of information within new queries. Furthermore, GQL is user extensible, provided the new operators have well defined semantics with respect to all datasources.

After the user specifies the query via the GUI layer 22, the GUI layer 22 collects all the relevant information and hands it to the Parser 24 layer.

Distributed, heterogeneous data access requires more than the ability to merely query data sources across networks. Query processing in large enterprises can entail weeks of work, different sets of requirements, multiple groups of people and departments. For example, the query designers (typically, the database designers and administrators) are not necessarily the final of the queries they design.

In addition, queries are often isomorphic, from a structural point of view. For example, the statement “SELECT count(*) FROM <datasource>” can be used to return the number of rows in any relational table. Rather than construct 100 (say) such queries for 100 tables, it would be far better if only one such “logical” query had to be constructed. Ideally, at run-execution-time the query could be matched with a specific source, and the instantiated query then executed.

These factors imply that an ideal distributed data access system would enable queries to be treated as abstract entities, that are, within certain natural constraints, easily instantiated for specific tasks. In the system 10, this goal is achieved through the mechanism of “binding plans.”

Using the Administrator, logical sources are mapped to physical sources, creating what is referred to a “binding plan”. A binding plan consists of source binding, where each source binding consists of taking a virtual source and a physical source and mapping their columns, such that every column in the former is mapped to some column in the latter (“column” binding). While column bindings are onto maps, they are not necessarily injective. That is, every logical column is mapped to some physical column, but the converse is not necessarily true. Thus, column bindings make up source bindings, which in turn make up binding plans. The Administrator enables binding plans to be incrementally constructed, be collected into projects, and in general, be manipulated like any other resource in Cerebellum.

Using the Designer, the query designer constructs a “virtual” query using “virtual” sources. Then binding plans are attached and the query is executed in the context of a particular binding plan. In Cerebellum, binding plans enable the logical design of queries and sources to be done independently of the details of the underlying physical sources.

Several important advantages are consequently realized: First, query processing can be split into parallel tasks, where one group sets up and maintains the actual physical database (schema designs, allocation of memory, index building), and another group works on building virtual queries. Second, binding plans facilitates the separation of logical or design-time issues from physical or run-time ones. Finally, binding plans allow queries to be reused, and to be interpreted in different contexts. Collectively, these benefits make Cerebellum a more efficient and productive database development environment.

Associated with every GUI implementation is a parser 24, which translates the information gathered in the GUI layer 22 into the internal data model of Cerebellum. For example, the standard GUI includes a graphical parser 24 that converts the information contained in GQL's structures to Cerebellum's internal query model. The parser 24 converts the GQL-specific elements into the language-independent query model. Also, the parser 24 performs a cursory optimization of the user specification to eliminate redundancy.

GQL is designed to support the addition of other operators. So, must the parser 24 be extensively rewritten to accommodate these revisions? The answer is no. We circumvented this problem by a careful blending of syntax trees with GQL graphs and Visitor design patterns. The developer only has to write a (Visitor) class to process the new graphical element in the diagram. This allows incremental development of the parser 24 for the standard GUI.

After the parser 24 process the information from the GUI layer 22, it passes the resultant Cerebellum query model to the next layer, the Partitioner 26.

After the parser 24 completes its task, the internal data model gives the system 10 enough information to execute the user's query. However, it is possible that the query could be simplified in a great many ways. For example, portions of the query could be rewritten, or conditional clauses could be combined and simplified. Further complicating matters is the fact that distributed, heterogeneous queries are quite different from their non-distributed counterparts. Network delays, unpredictable data transfer times, the conversion of data types between heterogeneous sources, subtle and unsubtle query dependencies, query nesting etc. can all add up to difficulties for the query optimizer. Cerebellum's partitioner 26 adopts the philosophy that as far as possible, the distributed, heterogeneous query should be partitioned into non-distributed, homogeneous partitions. Along with metadata information, each query partition is translated into agent specifications. Each agent specification contains enough information to devise an agent for executing the query partition.

In Cerebellum, agents 38 are optimized to run against only one datasource. A query involving more than one source requires the creation of more than one agent. The agents 38 then communicate to execute the query. The partitioner 26 optimizes agent creation to limit network traffic between agents 38 during execution.

The partitioner 26 uses datasource metadata to determine good plans to create and deploy agents 38. The globally optimal design of such plans is provably NP-complete; hence we do not use elaborate optimization schemes which precious processor cycles. For database-oriented queries this has another advantage. Many database engines such as Informix and Oracle already have very sophisticated query optimization routines. The agents 38 produced from the partitioner's 26 agent specifications hand over the query fragment to these routines which then proceed to optimize it further. In this way, the database itself handles a portion of the query optimization labor.

Generators 30 use metadata to convert the agent specifications into actual agents 38. Agents 38 are Java programs created from the query specification specifically to perform a part of one query. Each agent is optimized to execute only those commands absolutely necessary to complete the specific query it represents. The contents of the program--Java code--depends on the datasource against which the agent operates.

For example, a query that extracts information from a legacy VSAM file and inserts it into a relational Oracle database table is ultimately partitioned into two agents 38. One agent contains the COBOL code necessary to query a VSAM file for information. The other agent contains the SQL code that describes the insert into the Oracle database table.

The generator 30 layer is one of the core layers of the system 10. While the current generators 30 produce only Java agents 38, agents 38 based on other language technologies could be generated from the agent specification. The generator 30 layer is the last layer in the design time subsystem; the agents 38 it produces are the basic elements of the run-time subsystem. Since the latter subsystem is based on the pipe-and-filter design pattern, the generator 30 layer's task can be thought of as producing a pipe-and-filter system on the fly.

The run-time subsystem executes queries across multiple, distributed, disparate data sources. The run-time subsystem is loosely based upon the pipe-and-filter design pattern. This architecture meets the design criteria of optimized run-time performance. The filters in this case are the agents 38, which are the result of the generator 30 layer. Designing and compiling filters on the fly gives the Cerebellum's run-time system enormous power. In principle, the generator 30 layer could create agents 38 to perform almost any computational task. This, in combination with the traditional strengths of the pipe-and-filter architecture, makes the run-time subsystem unusually efficient.

The run-time subsystem is comprised of the following five entities:

Host machines/Operating Systems-These provide the basic operating environment for Cerebellum.

Agents 38-These are executable Java programs designed for the access and manipulation of datasources. Each agent is associated with one and only one datasource.

Agencies 36-These administer the execution of agents 38, and provide other services such as logging, persistence, security.

DataSources-The collection of data repositories that can be accessed and manipulated by Cerebellum.

Interaction Protocols-The entities can interact with one another via standard protocols such as TCP/IP for networks and CORBA for objects.

Agents 38 and Agencies 36 are described in greater detail in the next two sections.

Agents 38 are the core units of work within Cerebellum. Agents 38 operate directly on data sources to satisfy the query specification. The design-time subsystem of Cerebellum translates queries into one or more agents 38 depending on the complexity of the query or the number of data sources involved. The run-time system executes the agents 38 individually. When more than one agent is required to execute a query, the agents 38 communicate with one another to satisfy the request. Agents 38 are managed by agencies 36 (see FIG. 4); which ensure that the execution proceeds smoothly, errors are monitored, persistence, security, and a variety of other services described below.

Agents 38 are reactive and very simple. They execute when they are directed by outside forces. Agents 38 can only perform three operations: receive input, process, and send output. By accepting input and sending output from and to other agents 38, agents 38 can work together to handle queries against multiple, distributed, disparate information sources.

Agents 38 optimize the execution of a query in a number of ways. First, the agents 38 are mobile entities. The agents 38 reside close to the data source on which they will act, limiting the amount of network traffic during their execution. Second, a complex task involving multiple sources of information on multiple machines can be distributed to multiple agents 38. This divide-and-conquer approach enables processing to be conducted on multiple machines.

Cerebellum provides the capability to create parameters at run-time. In this case, placeholders are generated within the agent code to allow the dynamic binding of values.

Finally, agents 38 need be compiled only once. Unless the query changes in some manner, the same agent can be used over and over again. Agents 38 can be saved and managed like any other resource in Cerebellum.

A perceived drawback of the pipe-and-filter architecture is the concern that with a large number of filters and pipes, the resulting network would begin to look more and more like anarchy. This is indeed the case if filters were essentially independent entities. However, in the system 10, the agents 38 are not free agents 38. Instead, they operate under the supervision of agencies 36, which in turn are organized into loose federations. The administrator controls membership in the federation. Allocation of agents 38 to agencies 36 can either be automated or left under the administrator's control. The federations are relatively immutable entities, unlike agents 38 which are generated on the fly. Irrespective of how many agents 38 are generated, as long as the system's hardware resources are adequate, the run time subsystem can be operated in a controlled, yet flexible manner. Functionally, agencies 36 are the servers of Cerebellum. Agencies 36 serve as repositories for agents 38 as well as provide some core services that agents 38 may use.

Agencies 36 are associated with physical sources. Physical sources include relational databases, mainframes, file systems, and others. Each agency can manage one or more physical sources. Multiple agencies 36 can manage the same physical sources thus allowing a built-in fault tolerance mechanism. Therefore, agents 38 reside on the agencies 36 that manage the physical source against which the agent will operate.

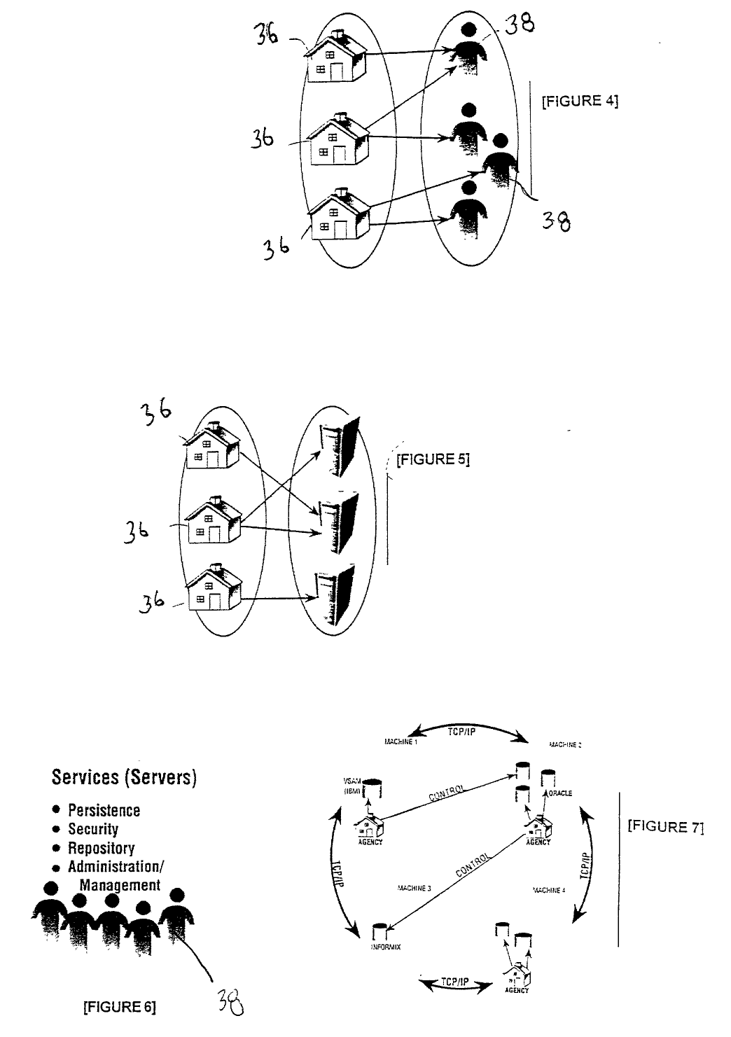

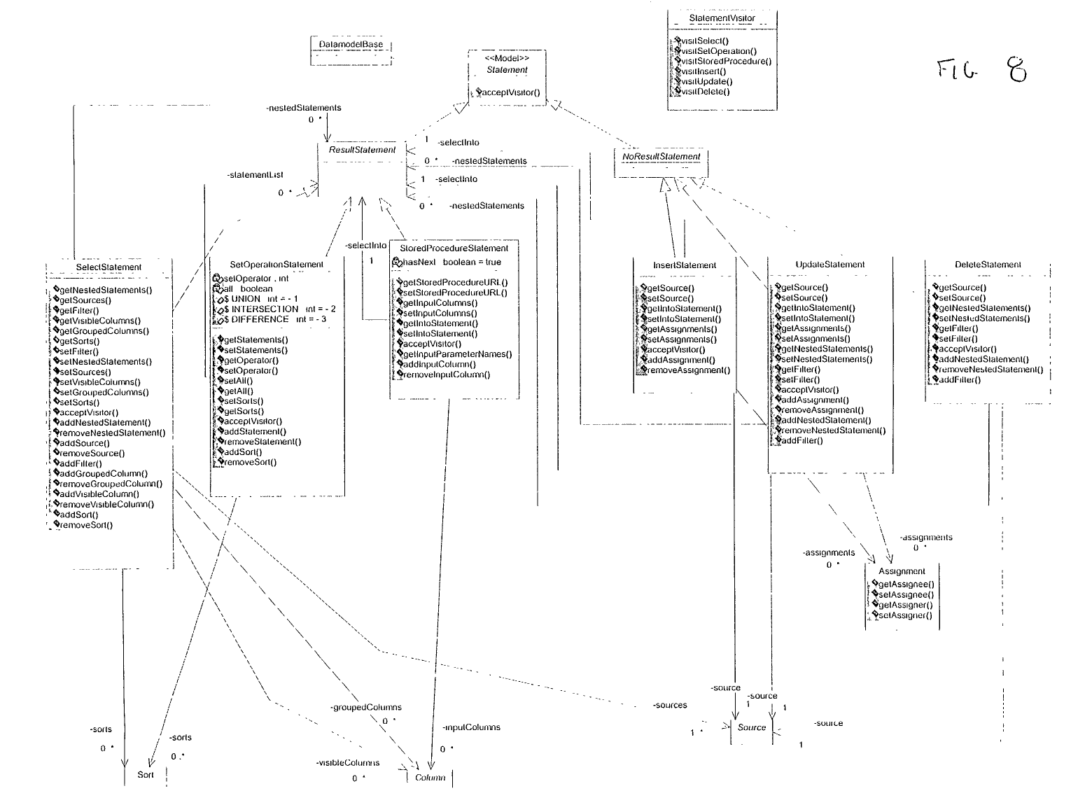

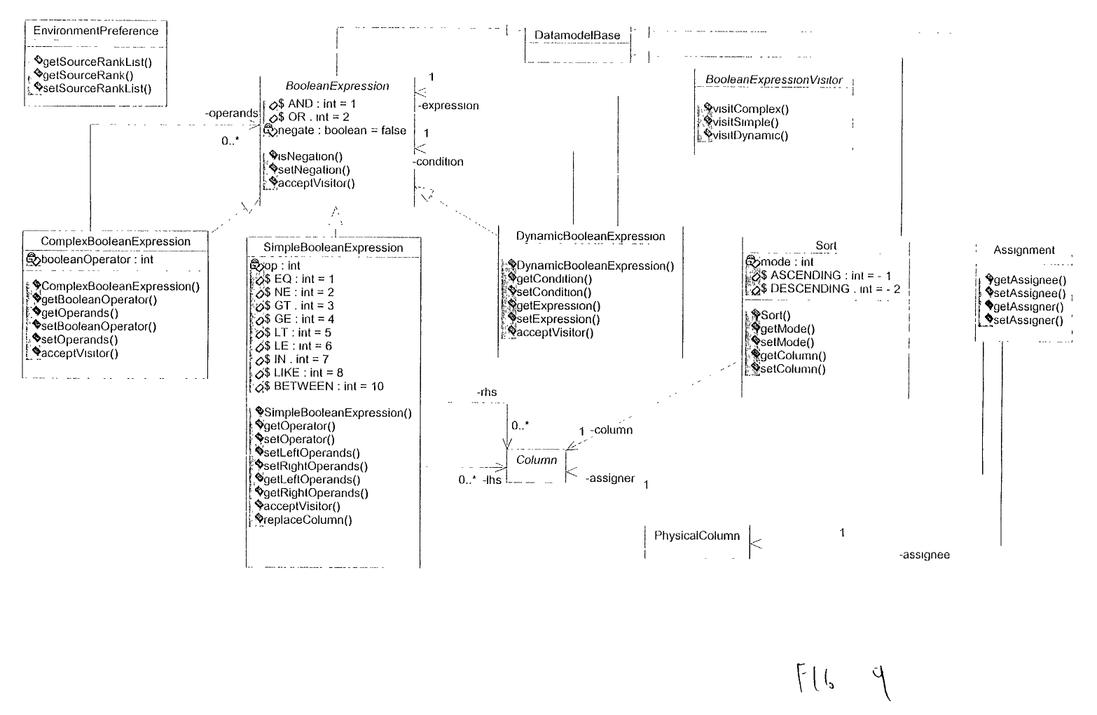

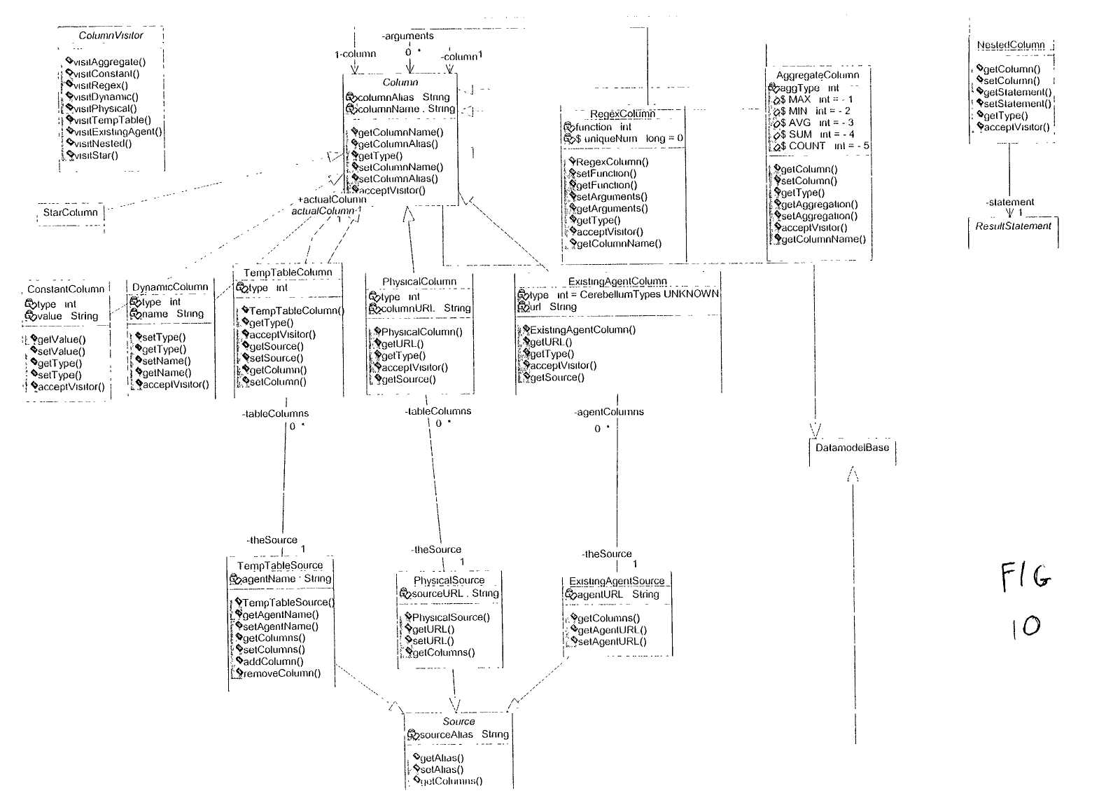

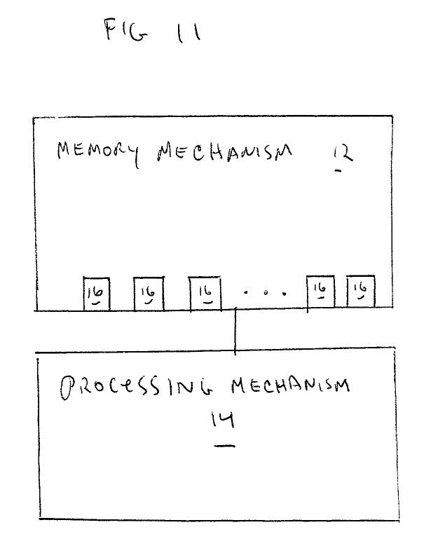

Agencies 36 also provide a set of core services that agents 38 and other entities within the system use. See FIG. 5. FIG. 5 shows the relationship of agencies 36 to physical machines; a machine may host more than one agency or an agency may control data sources on more than one machine. An Agency's services include persistence, resource pooling, logging, scheduling, metadata repository, and user management. See FIG. 6.

The agency provides the persistence of objects in the disk. The persistence service is flexible enough to handle different implementations. The current implementation utilizes object-oriented database technology to write object to physical disks. Persistence in the form of anticipatory metadata caching allows the GUI layer 22 to make fewer calls to the metadata repository. This greatly improves the response of the design time subsystem.

Opening connections to physical resources (e.g. files or databases) is an expensive operation. Repeated requests for connections creates bottlenecks in performance. The agency provides a mechanism for caching resources for reuse.

The run-time system is extensively logged to ensure that in the event of an error, its localization with respect to task, agent, agency and host machine is recorded. It is possible to set verbosity levels in the agency configuration files to prevent unimportant events from being logged.

An agency's scheduler is used primarily to do two things. It is responsible for performing various housekeeping tasks on the host machines. It is also capable of executing agents 38 at predefined instants. For example, a database table may need to have certain rows removed at midnight every night. After an agent is built to perform the removal task, it is registered with the scheduler to be executed at midnight, on a contining basis. In principle, the scheduler is currently capable of executing Java code; for this version however, its role is limited to these above two functions.

Information in the metadata repository describes the physical data sources on which Cerebellum operates. Idiosyncratic features of datasources can be partly encapsulated in the metadata object associated with the datasources. Metadata is defined and managed on the Agency; it is retrieved incrementally during the design-time process. Metadata guides the partitioner 26 as it develops agents 38.

User administration is an important service provided by the agency. The adding, deleting, monitoring and assigning of resources to users is handled by the agency and the Cerebellum Administrator package.

The problem of retrieving and manipulating data on a set of distributed, heterogeneous datasources is a highly complex one. Without the advances in agent and object oriented technologies, CORBA/DCOM infrastructure, and recent innovations in the Java programming model, the solvability of such a problem would be, in fact, doubtful. The system 10 builds on the available state-of-the-art technology to make disparate data integration a viable reality.

In the operation of the preferred embodiment, a main feature of the Cerebellum architecture is the separation between run-time and design-time processing. Run-time processing involves any working with data within physical databases. Design-time processing is work done constructing statements to work with data within a physical database. The specification and optimization of queries occur at design-time. Queries are actions on databases (e.g. retrieve information, insert information, etc.) . The product of the design-time processing is sent to and managed by the run-time processing. The product of the design-time processing is an agent. An agent contains database-specific commands to satisfy the user-specified query. A “library” of agents 38 reside in the run-time processing system (system being the software that performs the processing). The run-time processing is responsible for handling requests from users and executing the appropriate query. The run-time processing simply executes the agent corresponding to the user's request. The agent contain any intelligence to speak directly the database it needs to access.

Metadata is defined as “data about data.” Cerebellum must be able to execute the same queries on any type of database. This requires a mapping layer that maps abstract entities from physical entities. An example of an abstract entity is a database. A example of a corresponding physical entity is an Oracle 8.0.3 database running on a Solaris 2.6 operating system. The metadata serves as this layer. This is important because Cerebellum must abstract the details of specific entities from users. For example, each database is different and therefore has different properties. Exposing the specifics of these systems to users would require them to have intimate knowledge of each system (which defeats the purpose of Cerebellum). Cerebellum presents abstract entities like a physical source to users that provide a database-independent set of properties. The metadata layer has intelligence to map very specific properties of physical sources (database tables) to more generic properties of abstract entities (physical sources). The intelligence in mapping abstract to physical layers 32 involves writing the mechanism for an abstract entity to set it properties based on a physical entity. For example, a database has a property call “tables”. The metadata layer has the intelligence to know how to get the list of “tables” from an Oracle 8.0.3 database by passing it a certain set of commands specific it.

Cerebellum operates on relational entities. A relational entity is source of data structured into rows and columns. As long as a source of data can be structured in that manner, Cerebellum can connect to it.

Every entity in Cerebellum has metadata. Each entity has a set of properties that are required by Cerebellum. The entity may have more properties, but it can't have less. By guaranteeing that all physical entities adhere to the standards defined below, all entities regardless of type can be treated equally. A complete list of these entities is given below.

| Entity | Description | Required Properties |
|---|---|---|
| Virtual Source | A virtual source is a | Name |
| | relational source of | Columns |
| | data that exists only | |
| | in Cerebellum. It may | |
| | model a physical | |
| | environment, but it | |
| | exists solely with | |
| | Cerebellum. | |
| Virtual Column | A virtual column is a | Name |
| | column that only | Type |
| | exists in Cerebellum. | |
| Repository | A repository is a | Sources |
| | physical container of | Effectiveness |
| | sources. (for | |
| | example, database) | |
| Physical Source | A physical source is | Name |
| | an actual relational | Columns |
| | source of data. | EstimatedSize |
| | | Repository |
| PhysicalColumn | A column in a physical | Name |
| | source | Type |
| | | Size |
| Binding Plan | A set of | Name |
| | SourceBindings | SourceBindings |
| SourceBinding | A mapping between | VirtualSource |
| | physical and virtual | PhysicalSource |
| | source | ColumnBindings |
| ColumnBinding | A mapping between a | VirtualColumn |
| | physical and virtual | PhysicalColumn |
| | column | |

An example repository is a relational database. A database has many properties including tables. In Cerebellum, the metadata for this repository must map the table list into the sources property. Also the database must have a registered effectiveness-the quality of the database engine-in order to be a valid repository. Metadata drivers are written for each type of source to map the source-dependent information into Cerebellum properties.

The design time system encapsulates all of the work specifying and optimizing queries. The output of the design time subsystem is a group of objects that are generated specifically to perform the user's task. The design-time system is accompanied by two graphic user interfaces: designer and administrator. The designer GUI enables users to construct and execute queries. Administrator enables users to view metadata and make appropriate changes to support the construction of queries in designer.

GQL

Graphic Query Language is a new visual language created for specifying database independent queries. GQL visually depicts queries as dataflow. GQL is comprised of a set of graphic language elements, glyphs, each representing a certain action on data. Each glyph has sources and sinks. Glyphs are attached via their sources and sinks to create dataflow diagrams specifying queries. A table of the glyphs is enclosed below.

GQL Graphical Operators

| | |
|---|---|
| Join | Joins two streams of information together |
| Select | Specifies/Limits columns of information to be |
| | contained within the stream of information |
| Insert | Inserts data into a datasource |
| Update | Updates data within a datasource |
| Delete | Deletes rows within a datasource |
| Filter | Limits the rows upon which the action takes place |
| Aggregate | Aggregate rows of information together (sum, |
| | min, max, avg, count) |
| Source | A source of data (corresponds to virtual sources) |
| Sort | Sorts the rows of a query |
| Set operation | Union, intersection, or difference of two streams |
| ExistingQuery | Use an existing query as a source of information |
| Procedure | Execute a procedure in a datasource. |

The grammar for GQL is below:
{X} - Indicates a non-terminal X
[X] - Indicates a terminal X (glyph)
X | Y −> Indicates X | Y
X Y −> Indicated X followed by Y
X* −> Indicates 0 or more of X
X? −> Indicates 0 or 1 of X
X
X J −> Indicates 2 X's parallel, feeding into J
X
*
X J −> Indicates 2 or more instances of X feeding into J
[T] −> SourceGlyph (Table)
[Se] −> SelectGlyph
[F] −> FilterGlyph
[J] −> JoinGlyph
[RE] −> RegexGlyph
[A] −> AggregateGlyph
[So] −> SortGlyph
[O] −> SetGlyph
[I] −> InsertGlyph
[U] −> UpdateGlyph
[D] −> DeleteGlyph
[EA] −> ExistingAgentGlyph
[SP] −> StoredProcedureGlyph
{Query} −> {ResultBranch} | {TransactorBranch}
{ResultBranch} −> {SelectBranch} | {SetOpBranch}
{SelectBranch} −> ({SimpleSelect} | JoinBranch}) [A]? [So]?
{JoinBranch} −> {SimpleSelect}

*

{SimpleSelect} [J] {Mid}*

{SimpleSelect} −> {StartGlyph} {Mid}*
{StartGlyph} −> [T] | [EA]
{Mid} −> [Se] | [F] | [RE]
{SetOpBranch} −> {ResultBranch}

{ResultBranch} [O] [So]?

{TransactorBranch} −> {UpdateBranch} | (InsertBranch} |
{DeleteBranch} |
{StorProcBranch}
{UpdateBranch} −> {ResultBranch} [U] [F] * [T]
{InsertBranch} −> {ResultBranch} [I] [T]
{DeleteBranch} −> [T] [F] * [D]
{StorProcBranch} −> {ResultBranch} [SP]

Each glyph has a corresponding properties box. The properties box allows the user to specify information required by the glyph.

A parser 24 is a program that understands and interprets a language. The purpose of the parser 24 is to convert the GQL query into one query object. This object serves as the basis for query optimization and generation. The object model maps closely to SQL (structured query language). The model begins with the 6 basic types of statements (Select, Insert, Update, Delete, Set Operation, and Stored Procedure). All diagrams will be converted from a set of glyphs into one of the aforementioned objects. The parser 24 removes redundant glyphs and merges all functionality into one place for further processing.

In the Designer GUI and GQL, all notions of sources of data refer to virtual sources. A virtual source is Cerebellum-specific and has no reference to anything physical. The binder 28 replaces references of virtual sources with physical sources. The binder 28 is driven via a user-selected binding plan which has a list of sourcebindings. These sourcebindings serve as the guidelines for the search and replace.

The partitioner 26 is a distributed query optimizer. The partitioner 26 analyzes the bound object is receives from the binder 28. The output of the partitioner 26 is a blueprint of query execution. The partitioner 26 follows a strict set of algorithms. At a high level, the partitioner 26 picks a place to perform the work, and it moves all other data to that place. Here is a description of the algorithm for each type of statement:

Select: Find the source on the machine with the most amount of data located on it and create one agent. For every other source, if it is not on the same machine, create another agent add the main agent as one of its sinks. Looks at nested statements. If any nested statement depends on a different machine than the main agent, a new agent will be created.

Insert: Identify the source where the insert will take place and create an agent. If the insert requires data from any other machine, create an agent to grab the data and send it to the main agent.

Update: same as insert

Delete: Create one agent to perform the delete.

StoredProcedure: Create one to execute the stored procedure.

Each different type of source requires a code generator 30. These generators 30 create agents 38 based on the specifications provided by the partitioner 26. There are code generators 30 for each type of source. Currently there are two classes of code generators 30 in Cerebellum: JDBC-based (relational databases) and file system.

JDBC generation is based on creating agents 38 that communicate with data source using the Java Database Connectivity library (JDBC). The generator 30 understands how to generate code to open connections to JDBC datasources, construct queries for these systems, and retrieve results from the systems. The JDBC generator 30 uses metadata and the object model to construct an individual agent. The structure of an agent is described below.

The run-time environment is a distributed network of agents 38. Agents 38 collaborate to solve complicated tasks. Agents 38 are architected to a standard pipe-and-filter architecture. Each agent behaves as a filter on data and passes on information to other agents 38.

An agent is generated via the design-time system for a specific task. An agent runs against only one datasource. An agent has performs three main actions: input, process, and output. In input, an agent receives input from another agent and handles it accordingly. In process, the agent performs the task it was really meant to do. In output, it sends data it creates to other agents 38 if applicable.

| Here is the pseudo-code of a typical agent: | |
|---|---|
| AGENT BEGIN: | |
| Input(Row) | { |
| | If I expect input |

Insert it into a temporary stored table

If I have all the data I need

Process( )

| | |
|---|---|
| } | |
| Process ( ) | { |
| | Get username and password |
| | Open connection to database |
| | Execute query |
| | While I have results |

Output(Row)

| | |
|---|---|
| } | |
| Output(Row) | { |
| | If I have any sinks |

Sinks.input(Row);

}
AGENT END;

### EXAMPLE

Here is an example of life-cycle of a query from start to finish. One Oracle database exists on a Sun SPARC containing medical patient records. One Microsoft SQLServer database exists on a PC containing admissions. As an example, a patient's record is combined with information on when he was admitted.

Setup Work:

Install a copy of Cerebellum Server (Agency) on each machine with the database.

Use Cerebellum administrator to direct Cerebellum to connect to the two databases and read the metadata from the databases. Make sure that physical sources exist for the requested information (patient information and admission info).

Create two virtual sources that have the same columns as the physical tables in interest. Make sure the columns have the same types as those in the databases.

Create a binding plan mapping the two sets of sources to each other.

Example Metadata (created from above 4 steps)

| | Example | |
|---|---|---|
| Type | Name | Properties |
| Repository | Database1 | Sources: source1, source2 |
| | | Effectiveness: 5 |
| | | DatabaseName: Oracle |
| Physical | Source1 | Name: source1 |
| Source | | Columns: s1c1, s1c2, s1c3 |
| | | EstimatedSize: 30 |
| | | Repository: Database1 |
| Physical | S1c1 | Name: s1c1 |
| Column | | Type: CHARACTER |
| | | Size: 15 bytes |
| Physical | S1c2 | Name: s1c1 |
| Column | | Type: CHARACTER |
| | | Size: 2 bytes |
| Physical | S1c3 | Name: s1c1 |
| Column | | Type: NUMERIC |
| | | Size: 1 |
| Virtual | Vs1 | Name: vs1 |
| Source | | Columns: vs1c1, vs1c2, vs1c3 |
| Virtual | Vs1c1 | Name: vs1c1 |
| Column | | Type: CHARACTER |
| Virtual | Vs1c2 | Name: vs1c2 |
| Column | | Type: CHARACTER |
| Virtual | Vs1c3 | Name: vs1c3 |
| Column | | Type: NUMERIC |
| Binding Plan | Binding1 | Name: binding1 |
| | | SourceBindings: sb1 |
| SourceBinding | Sb1 | Name: sb1 |
| | | PhysicalSource: source1 |
| | | Virtual Source: vs1 |
| | | ColumnBindings: sb1cb1, sb1cb2, |
| | | sb1cb3 |
| ColumnBinding | Sb1cb1 | Physical Column: s1c1 |
| | | Virtual Column: vs1c1 |
| ColumnBinding | Sb1cb2 | Physical Column: s1c2 |
| | | Virtual Column: vs1c2 |
| ColumnBinding | Sb1cb3 | Physical Column: s1c3 |
| | | Virtual Column: vs1c3 |

Creating the Query:

Construct the query using GQL. Attached is a query showing a query connecting two virtual sources of data. Set properties on the Join glyph instructing Cerebellum that the two virtual sources should be joined on a common piece of datum. The user chooses that the two virtual sources will be joined by finding all the records where column1 in source1 is equals to column2 in source2. Metadata used: Virtual Source and Virtual Columns.

Select the Execute query item in the menu. Cerebellum will require the user to select a binding plan. Select the binding plan created for this task from above. Hit next.

The Parser 24 will receive the diagram (the connected glyphs) and check that the diagram is syntactically correct (see grammar above). The Parser 24 will convert the diagram into Cerebellum's existing datamodel. The parser 24 visits each glyph in the GQL diagram and determines the corresponding internal object representation. The output of this step will be an object of type SelectStatement. (Please see the model attached). The parser 24 will populate the properties of the SelectStatement. In this example the filter will get set on the SelectStatement with the criteria defined above.

The Binder 28 will receive the statement and the specified binding plan. The binder 28 will search for each virtual source, look up the corresponding physical source according to the binding plan. And replace each reference of the virtual source and virtual column with the corresponding physical source and column respectively. Metadata used: Binding Plan, Source Bindings, and Column Bindings.

The Partitioner 26 is responsible for creating blueprints of the agents 38 that need to be created. The Partitioner 26 will understand that the provided statement has elements residing on two different machines. The Partitioner 26 will create blueprints for two agents 38. Agent 1 will get all of the information about the admission data from the SQLServer database and send the results to Agent 2. Agent 2 will receive the information from Agent 1 and create a temporary storage facility for the information in the Oracle database. After Agent 2 receives the last record from Agent 1, Agent 1 performs the final query against the database using the temporary records from Agent 1. Metadata used: Physical source, Repository, and Physical column.

The blueprints are send the generators 30 which generate Java code specific to the tasks specified by the Partitioner 26. Two agents 38 will be generated. One agent will perform a SELECT statement on Microsoft SQLServer and sent its results to the other agent. The other agent will create a temporary for the incoming records in Oracle. For each incoming record, the agent will perform an INSERT into the Oracle table. After it is done receiving records, it performs a SELECT statement from the patient table and the temporary table and returns the results. Metadata used: physical source and physical column.

Each generated Java code is shipped to an agency. It is shipped to the agency that was set-up to manage (know about) the physical source of data that it needs to access. After the agency receives the Java code, the agency compiles the code.

Run-Time Work

After the code is resident and compiled on the machine where the agency resides, it is ready for execution. Upon the user's request, the agency instantiates the agent and returns a reference to it. The user is then free to execute the provided agent. Agent execution will begin the process described above by the agent blueprint.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

What is claimed is:

1. A system for accessing data comprising:
a memory mechanism having the data; and
a mechanism for processing a query for the memory mechanism which is icon based, said memory mechanism connected to the processing mechanism.

2. A system for accessing data comprising:
a memory mechanism having N heterogeneous memory sections having the data, where N is greater than or equal to 2 and is an integer; and
a mechanism for processing a query for at least two of the N memory sections, said memory mechanism connected to the processing mechanism.

3. A system for accessing data comprising:
a memory mechanism having the data; and
a mechanism for processing queries along respective query paths for the memory mechanism, said processing mechanism having predefined query paths to process queries, said memory mechanism connected to the processing mechanism.

4. A method for accessing data comprising the steps of:
formulating a query for a memory mechanism having the data by selecting an icon on a computer screen to form an icon based query; and
processing the icon based query for the memory mechanism.

5. A system for accessing data comprising:
a design time processing portion which prepares a query for data into a desired query form and a run time processing portion which operates on the desired query form solely to obtain data responsive to the desired query form, said run time processing portion connected to but separate and apart from the desired design time processing portion.

6. A system as described in claim 5 wherein the design time processing portion includes a GUI layer in which a query is specified.

7. A system has described in claim 6 wherein the design time processing portion includes a parser layer connected to the GUI layer which converts the query from the GUI layer into a desired form.

8. A system as described in claim 7 wherein the run time processing portion has physical memory sections, and wherein the design time processing portion includes a binder that takes the query and references physical memory sections to it, said binder connected to the parser layer.

9. A system as described in claim 8 wherein the design time processing portion includes a partitioner layer which separates the query into fragments, said partitioner layer connected to the binder.

10. A system as described in claim 9 wherein the design time processing portion includes a generator layer which creates agents responsible for executing the fragments, said generator layer connected to the partitioner layer.

11. A system as described in claim 10 wherein the run time processing portion processes the agents.

12. A system for accessing data comprising:
a memory mechanism having N memory sections having the data, where n is greater than or equal to 2 and is and integer; and
a mechanism for processing a query which simultaneously obtains data from the N memory sections.

13. A system as described in claim 12 wherein the processing mechanism includes a partitioner which creates a plan for simultaneously obtaining data from the N memory sections in response to the query.

14. A system for accessing data comprising:
a physical layer in which data having a format is stored;
a virtual layer in which a query is formed regarding the data, said query having no knowledge of the format of the data in the physical layer and is independent of the format of the physical layer; and
a binder which operates on the query to obtain data responsive to the query, said binder connected to the physical layer and the virtual layer.

15. A system as described in claim 14 wherein the physical layer includes a plurality of memory sections, each memory location having a minimum number of properties.

16. A system as described in claim 15 wherein the blinding layer maps a query to data in the memory sections.

17. A system as described in claim 16 wherein the binder filters which data from the memory sections can be provided in response to the query.
